(19) United States
(12) Patent Application Publication
(10) Pub. No.: US 2008/0201490 A1
(43) Pub. Date: Aug. 21, 2008

(54) FREQUENCY DOMAIN DATA MIXING METHOD AND APPARATUS

(76) Inventors: Schuyler QUACKENBUSH, Westfield, NJ (US); Laurence Ruedisueli, Berkeley Heights, NJ (US)

Correspondence Address: MALDJIAN & FALLON LLC, 365 BROAD ST. , 3RD FLOOR, RED BANK, NJ, 07701, US

(21) Appl. No.: 12/020,356

(22) Filed: Jan. 25, 2008

Related U.S. Application Data
(60) Provisional application No. 60/886,510, filed on Jan. 25, 2007.

(51) Int. Cl. G06F 15/16

(52) U.S. Cl. 709/247; 709/246

(57) ABSTRACT

Embodiments of the present invention generally relate to a method and apparatus for mixing a data signal in a frequency domain so as to realize computational efficiency and reduced latency. In one embodiment, a method of processing data comprises generating a data signal at a client, encoding the data signal at the client using a linear transform to generate a time frequency coefficients, transmitting the time frequency coefficients to a server, modifying the time frequency coefficients in accordance with instructions to create modified time frequency coefficients, transmitting the modified time frequency coefficients to the client; and decoding the modified time frequency coefficients using an inverse linear transform.

### CROSS-REFERENCE TO RELATED APPLICATIONS

This application claims the benefit of U.S. Provisional Patent Application Ser. No. 60/886,510, filed Jan. 25, 2007, entitled “Frequency Domain Data Mixing Method and Apparatus,” which is incorporated herein by reference in its entirety.

### BACKGROUND

1. Field of the Invention

Embodiments of the present invention are generally related to a method and apparatus for mixing a data signal. More specifically, embodiments of the present invention relate to a method and apparatus for mixing a data signal in a frequency domain so as to realize computational efficiency and reduced latency.

2. Description of the Related Art

In general, data mixing via a global computer network has been known for decades. Such data mixing often occurs in a time domain, i.e., represented as a waveform as a function of time. However, such time domain data mixing results in long delays and latencies in the transmission of such data between and clients and servers. Such long delays and latencies make certain real-time audio collaboration via computer networks very difficult.

Attempts have been made at mixing in a frequency domain, i.e., using time frequency coefficients as a result of encoding certain data signals using linear transforms. While such attempts have largely overcome high transmission latency issues, new issues arise with respect to delays caused by increased computer processing complexity.

Therefore, there is a need in the industry for low-delay and low-complexity data mixing method and apparatus.

### SUMMARY

Embodiments of the present invention relate to a method and apparatus for mixing a data signal in a frequency domain so as to realize computational efficiency and reduced latency. In one embodiment, a method of processing data comprises generating a data signal at a client, encoding the data signal at the client using a linear transform to generate a time frequency coefficients, transmitting the time frequency coefficients to a server, modifying the time frequency coefficients in accordance with instructions to create modified time frequency coefficients, transmitting the modified time frequency coefficients to the client; and decoding the modified time frequency coefficients using an inverse linear transform.

In another embodiment, a method of mixing data signals comprises generating a first data signal at a first client and a second data signal at a second client, encoding the first data signal at the first client using a linear transform to generate first time frequency coefficients, encoding the second data signal at the second client using a linear transform to generate second time frequency coefficients, transmitting the first and second time frequency coefficients to a server, creating a first mix by combining the first and second time frequency coefficients in accordance with instructions from the first client, creating a second mix by combining the first and second time frequency coefficients in accordance with instructions from the second client, transmitting the first mix to the first client, and the second mix to the second client, and decoding the first mix at the first client and the second mix at the second client, using an inverse linear transform.

In yet another embodiment, a system comprises a first set of Huffman coded time frequency coefficients from a first client, a second set of Huffman coded time frequency coefficients from a second client, a mixer having a decoder, for mixing the first and second sets of Huffman coded time frequency coefficients, a first unique mix, for the first client, generated by the mixer, and a second unique mix, for the second client, generated by the mixer.

### BRIEF DESCRIPTION OF THE DRAWINGS

So the manner in which the above recited features of the present invention can be understood in detail, a more particular description of embodiments of the present invention, briefly summarized above, may be had by reference to embodiments, one of which is illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments.

FIG. 1 depicts a block diagram of a general computer system in accordance with one embodiment of the present invention;

FIG. 2 depicts a block diagram of a system in accordance with one embodiment of the present invention;

FIG. 3 depicts a block diagram of a system in accordance with one embodiment of the present invention;

FIG. 4 depicts a diagram of a system and associated data flow in accordance with an exemplary embodiment of the present invention; and

FIG. 5 depicts the latencies associated with a signal flow, from a client analog to digital (A/D), through the audio server mixer, and back to the client digital to analog (D/A), in accordance with one exemplary embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a method and apparatus for mixing a data signal. More specifically, embodiments of the present invention relate to a method and apparatus for mixing a data signal in a frequency domain so as to realize computational efficiency and reduced latency.

FIG. 1 depicts a block diagram of a general computer system in accordance with one embodiment of the present invention. The computer system 100 generally comprises a computer 102. The computer 102 illustratively comprises a processor 104, a memory 110, various support circuits 108, an I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

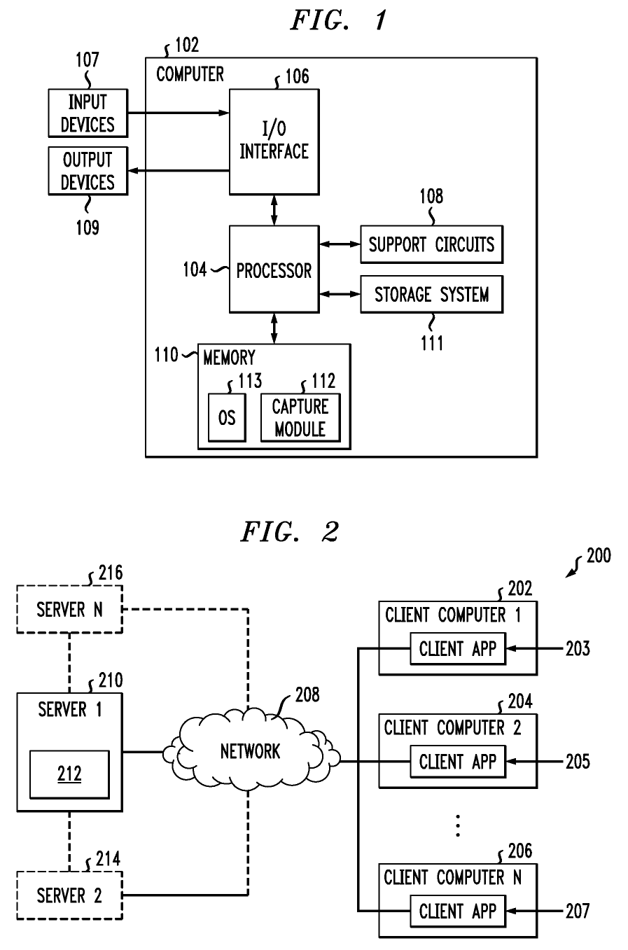

FIG. 2 depicts a block diagram of a system in accordance with one embodiment of the present invention. The system 200 depicted in FIG. 2, is described in detail in related U.S. patent application Ser. No. 11/740,794, published as U.S. Patent Application Publication No. 2007/0255816, the disclosure of which is incorporated herein by reference in its entirety. As understood by embodiments of the present invention, such systems, as disclosed by the referenced application publication, may support the methods and apparatus disclosed herein.

The system 200 generally comprises a first client computer 202, a second client computer 204, and additional client computers, up to client computer N 206, where N represents any number of client computers practical for operation of embodiments of the present invention. The system 200 further includes a network 208, a server 210, a mixer 212, and optionally a plurality of N additional servers (e.g., 214 & 216). The network 208 may be any network suitable for embodiments of the present invention, including, but not limited to, a global computer network, an internal network, local-area networks, wireless networks, and the like.

The first client computer 202 comprises a client application 203. The client application 203 is generally software or a similar computer-readable medium capable of at least enabling the first client computer 202 to connect to the proper network 208. In one embodiment, the client application 203 is software, commercially available by Lightspeed Audio Labs of Tinton Falls, N.J. In another embodiment, the client application 203 further provides instructions for various inputs (not shown), both analog and digital, and also provides instructions for various outputs (not shown), including a speaker monitor (not shown) or other output device. The second client computer 204 and client computer N 206 also comprise respective client applications (205, 207).

The server 210 may be any type of server, suitable for embodiments of the present invention. In one embodiment, the server 210 is a network-based server located at some remote destination (i.e., a remote server). In other embodiments, the server 210 may be hosted by one or more of the client computers. Additional embodiments of the present invention provide the server 210 is located at an internet service provider or other provider and is capable of handling the transmission of multiple clients at any given time.

The server 210 may also comprise a server application (not shown). The server application may comprise software or a similar computer-readable medium capable of at least allowing clients to connect to a proper network. In one embodiment, the server application is software, commercially available by Lightspeed Audio Labs of Tinton Falls, N.J. Optionally, the server application may comprise instructions for receiving data signals from a plurality of clients, compiling the data signals according to unique parameters, and the like.

The mixer 212 may be any mixing device capable of mixing, merging, or combining a plurality of data signals at any one instance. In one embodiment, the mixer is a generic computer, as depicted in FIG. 1. In another embodiment, the mixer 212 is capable of mixing a plurality of data signals, in accordance with a plurality of different mixing parameters, resulting in various unique mixes. The mixer 212 is generally located at the server 210 in accordance with some embodiments of the present invention. Alternative embodiments provide the mixer 212 located at a client computer, independent of server location.

As is understood by one of ordinary skill in the art, multiple servers may be the most efficient methods of communication between multiple clients when particular constraints exist. In one embodiment, multiple servers are provided to support multiple clients in a particular session. For example, in one embodiment, a group of three clients are connected through a first server 210 for a first session. A group of five clients want to engage in a second session, but the first server 210 is near capacity. The group of five clients are then connected through the second server 214 to allow for a session to take place.

For example, in another embodiment, a server 210 hosting a mixer 212 is provided in a system 200. As the server 210 becomes congested with multiple client transmissions, it may be beneficial to allow some of the clients to pass through a second server 214, thus relieving the bandwidth on the server 210. The second server 214 and first server 210 may be connected to one another through the network and/or any other known communication means to provide the most efficient methods of communication. If necessary, additional server N 216, where N represents any number of servers practical for operation of embodiments of the present invention, may be utilized as well.

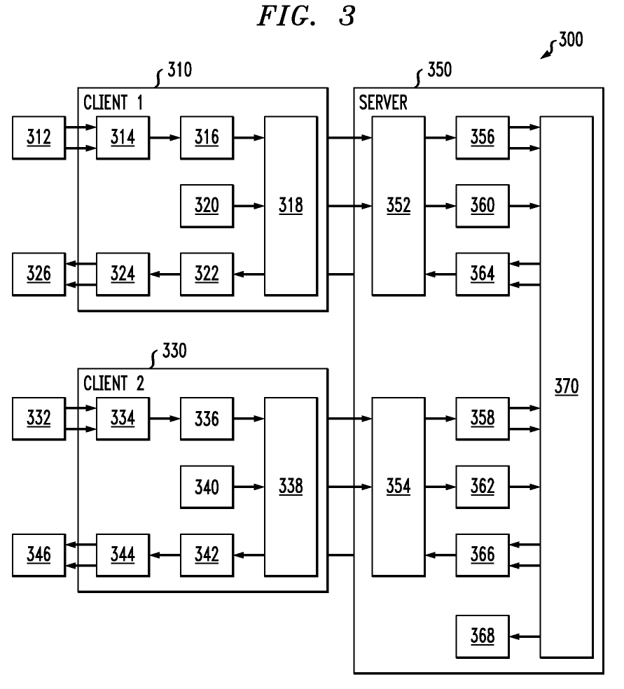

FIG. 3 depicts a block diagram of a system in accordance with one embodiment of the present invention. The system 300 generally comprises at least a first client 310, a second client 330, and a server 350. Optionally, a plurality of additional clients (not shown) or servers (not shown) may be provided without deviating from the structure of embodiments of the present invention.

In one embodiment, the first client 310 comprises an input device 312, an output device 326, and an interface 318 for connecting to the server 350. The first client 310 may also comprise an input sample rate converter 314, audio encoder 316, audio decoder with error mitigation 322, and output sample rate converter 324. Optionally, the first client 310 comprises a mix controller 320 having a graphical user interface.

The input device 312 comprises at least one of any musical instrument (e.g., guitar, drums, bass, microphones, and the like), other live or pre-recorded audio data (e.g., digital audio, compact disc, cassette, streaming radio, live concert, voice(s)/vocal(s), and the like), live or pre-recorded visual data, (e.g., webcam, pre-recorded video, and the like), other multimedia data, and the like. The output device 326 comprises at least one of headphones, speaker(s), video monitor, recording device (e.g., CD/DVD burner, digital sound recorder, and the like), means for feeding to other location, and the like.

The second client 330 similarly comprises an input device 332, an output device 346, an interface 338 for communicating with the server 350, an input sample rate converter 334, audio encoder 336, audio decoder with error mitigation 342, and output sample rate converter 344. Optionally, the second client 330 comprises a mix controller 340 having a graphical user interface. The input device 332 and output device 346 are substantially similar to the first client input device 312 and output device 332, respectively.

The server 350 generally comprises a first interface 352 for communicating with the first client 310, a second interface 354 for communicating with the second client 330, and a mixer 370. The server 350 may also comprise a first and second audio decoder with error mitigation 356, 358, a first and second controller for processing mix parameter instructions 360, 362, a first and second audio encoder 364, 366, and a status console 368. The status console 368 provides a visual and/or audio indication of the status of the system 300, at any given time during operation.

The mixer 370 is provided to perform the mix of multiple client data signals into single, stereo, or multi-channel signals (e.g., 5.1 Channel Sound). For audio signals, a mix is generally understood as the addition or blending of wave forms. The mixer 370 generally comprises a plurality of input and output channels, equal to at least the number of clients communicating with the server 350 at any given time.

In one embodiment, at the server 350, an executable program coordinates the transmission of compressed audio and control data over an IP channel between at least the first client 310 and server 350 and also coordinates similar audio-related routines. In such an embodiment, the server 350 audio decoder 356 receives compressed audio from the client 310 and reproduces the data signals (e.g., instrument and voice signals) and presents these to the mixer 370. Another server 350 module receives mix control parameters from the client 310 and presents them to the mixer 370. The server 350 audio encoder 364 receives the mixed stereo signal associated with a given client 310, compresses it, and presents it to the IP interface 352 for transmission to the client 310.

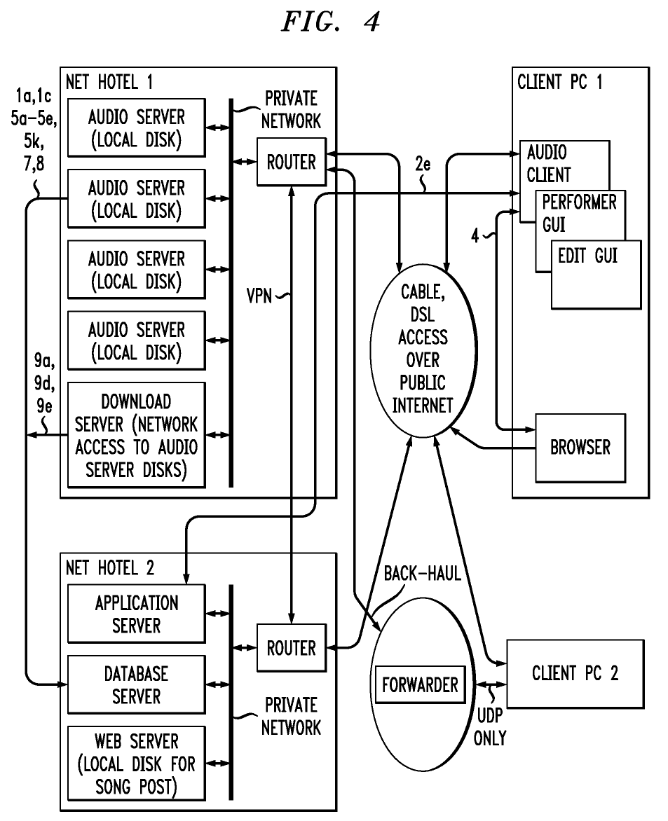

FIG. 4 depicts a diagram of a system and associated data flow in accordance with an exemplary embodiment of the present invention. More specifically, FIG. 4 depicts an audio engine and central servers, as well as a plurality of communication paths and exemplary communication messages.

In the depicted exemplary embodiment, several audio servers and an associated download server are present in one net machine (i.e., net “hotel”). An application server, database server and web server are depicted as present in another net hotel. From each hotel, the machines are connected via a dedicated router, and hence have an effective private network. Both of these private networks may be connected via a virtual private network (VPN) terminated at routers to form a seamless private network. A browser on a client PC and an audio client, also on the client PC, are connected to a public port of the web server or the audio server via an accessible computer network (e.g., the Internet).

In this exemplary embodiment, the client collects audio input from a performer client or “primary fan” and presents it to the audio server. Other performer clients may do the same, and present audio input to the audio server. The audio server combines (i.e., mixes) the audio input signals from the various performer clients and returns the mix to back to each Client.

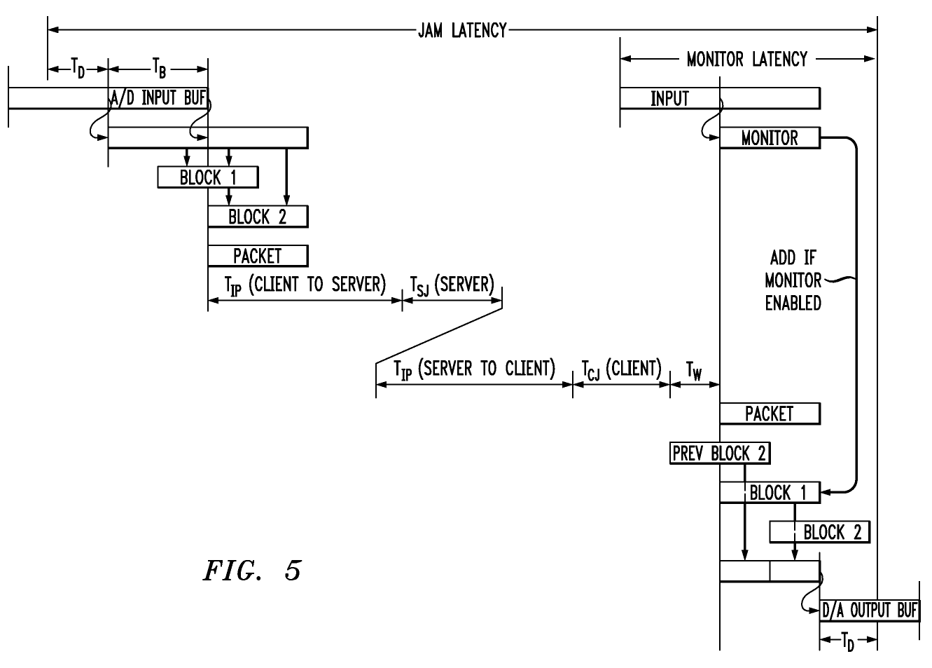

FIG. 5 depicts the latencies associated with a signal flow, from a client analog to digital (A/D), through the audio server mixer, and back to the client digital to analog (D/A), in accordance with one exemplary embodiment of the present invention. In the exemplary embodiment shown in FIG. 5, only significant latency durations are illustrated.

Table 1, shown below, represents exemplary time duration estimates for each component of the signal flow path in accordance with the exemplary embodiment depicted in FIG. 5. As shown in the table, the round-trip time is dominated by three components: Block time T_{B}, IP channel latency T_{IP}, and jitter buffer latency, T_{J}.

TABLE 1

| Location | Module | Delay | Comment |
|---|---|---|---|
| Client | Audio driver | T_{D} (0.5 ms) | Additional delay in audio driver |
| Client | Audio driver | T_{B} (5.3 ms) | Time to fill a 256 sample buffer at |
| | | | 48000 kHz sampling rate. |
| Client | Audio encoder | Tₑ (50 μsec) | Encoding is ~100 × real time. Window |
| | | | is 256 samples long. Process with 50% |
| | | | overlap and encode. Send two encoded |
| | | | blocks per packet: |
| | | | last 128 from previous block and |
| | | | first 128 from this block |
| | | | 256 from this block |
| IP | | T_{IP} (~10 ms) | IP delay from Client to Audio Server. |
| Channel | | | |
| Server | Input FIFO | T_{SJ} (5 ms) | Server jitter buffer delay |
| Server | Audio decode with | T_{dme} (40 μsec) | Decode to MDCT T/F coefs, Mix in |
| | simple error | | domain, encode from T/F coefs. |
| | mitigation, mix, | | |
| | audio encode | | |
| IP | | T_{IP} (~10 ms) | IP delay from Audio Server to Client. |
| Channel | | | |
| Client | Input FIFO | T_{CJ} (5 ms) | Client jitter buffer delay |
| Client | Audio thread | T_{w} (2.5 ms) | Average wait time for next A/D/A |
| | | | ping-pong occurance. |
| Client | Audio decoder | T_{d} (100 μsec) | Decode with mitigation is ~50 × real |
| | (possibly complex) | | time. Jitter buffer is in packet domain |
| | error mitigation | | that error mitigation can be in TIF |
| | | | domain. Decode two time blocks. |
| Client | Audio driver | Tₒ (0.5 ms) | Additional delay in audio driver |
| Total | | 37.5 ms | ~T_{D} + T_{S} + T_{IP} + T_{SJ} + T_{IP} + T_{D} + |
| | | | T_{w} + T_{D} |

In accordance with alternative embodiments of the present invention, the following may be incorporated in conjunction with or in lieu of other features disclosed herein.

In some embodiments, clients can connect to an audio server over DSL or Cable. Often this requires enhanced system diagnostics to collect statistics of jitter and packet loss (lateness) for specific links associated with cable modems, such as auto-adaptation of the size of jitter buffers to account for each client's link delay. Because of an inherent latency and error mitigation trade off in the embodiments of the present invention, a user can set a preferred “maximum latency.” Often the audio server has relatively more robust error mitigation solution. For example, server mitigation based on a client-computed and transmitted “packet similarity” metric, or a client mitigation based on prediction from past specific coefficients.

### Frequency-Domain Mixing

In another embodiment of the present invention, a method and apparatus for frequency-domain mixing are provided. The following discloses may be understood with respect to any of the systems disclosed herein, as well as other understood data transmission systems, wherein data signal mixing may be utilized.

In one embodiment, there are multiple clients connected to a single server. The clients generally send one or more channels of audio to the server where they are combined and distributed back to the clients. The signals are encoded, mixed and distributed back to the clients, so each client hears every other client's signals in a mixed ensemble.

Generally the clients communicate over a public internet infrastructure, for example a cable modem or DSL modem, whose bandwidth is usually limited. Thus it is desirable to compress the audio signal. In embodiments where a server mixer is utilized, the compressed audio signal is sent to the server mixer.

At the server mixer, full decoding of the plurality of audio signals and re-encoding after a mix has occurred is computationally complex and causes undesirable additional time delay. Thus, in many embodiments, it is advantageous for the server to not require a full decode of the compressed audio signal into the time domain.

In one embodiment, a partial decode at the server is provided from a set of Huffman code words to a set of time frequency coefficients. As understood by embodiments of the present invention, the time frequency coefficients are the signal representation immediately prior to the final step of inverse transform computation into the time domain.

In one embodiment, the transform used in the compression technique comprises a fully linear transform. For example, in many embodiments, the linear transform is one of a Modified Discrete Cosine Transform (MDCT) or a Fast Fourier Transform (FFT). In alternative embodiments, any orthogonal transform may be utilized. In such instances, mixing in the frequency domain (i.e., mixing with time frequency coefficients) is substantially similar to mixing in the time domain.

In an exemplary operation, embodiments of the present invention add a plurality of clients' data signals in the frequency domain (i.e., utilizing time frequency coefficients). During mixing, the gain and panning of an individual channel may be adjusted into a stereo signal. However, a signal delivered to the client may also be multi-channel, for example, 5.1 channels.

In accordance with embodiments of the present invention, one result of mixing in the frequency domain is a computational savings of performing an inverse transform and forward transform on the server. Furthermore, embodiments of the present invention often do not require any time representation be considered. However, one trade-off of remaining solely in the frequency domain, is the clients' data signals may not be monitored at the mixer (e.g., where audio signals are encoded as time frequency coefficients, no wave form is present at the mixer).

In the following exemplary embodiment, the general methods and apparatus of the present invention may be utilized as described. In one embodiment, a plurality of clients establish a connection to an audio server via a UDP connection and/or a TCP connection. As generally understood, a TCP connection is commonly used for control. For example, the gain on a particular signal to be increased in the mix of a particular client is received via TCP. A UDP connection is generally used for transmission of a coded signal.

In the client platform, there is generally an ability to have one or more channels of audio to digital (A/D) conversion. An analog audio signal of the client location (for example, a microphone or musical instrument) is connected to the client platform and converted to a digital signal (for example, a stereo A/D converter). This signal is buffered in the application and presented to an audio encoder. In one embodiment, the encoder has a very short block, i.e., it compresses a very small interval of input waveform. For example, in one embodiment, 128 samples at 48 KHz sampling.

In one embodiment, to compress the digital signal, a modified discrete cosign transform takes an interval of input wave form and transforms it into a set of time-frequency coefficients. In some embodiments, the transform takes about two interval blocks and produces about one interval block worth of output, with an overlap. In one embodiment, a suitable maximally decimated filter ban is also utilized.

Once the time frequency coefficients are created, an encoder function, used to model human hearing, sets quanitizer thresholds. Using such quantizer thresholds, the time frequency coefficients are converted from a floating point number into scale factors and integer values. In yet another embodiment, the scale factors and integer values are further encoded using Huffman coding.

Huffman coding is often used to encode two time interval blocks at once, and the time frequency coefficients are ordered, for example, from low frequency to high frequency. In one embodiment, a two dimensional array is created using the Huffman coding. One dimension of the array is equal frequency and increasing time, and the other dimension of the array is equal time and increasing frequency.

In certain embodiments, not utilizing a Huffman coding, there may be redundancy for a frequency across two time intervals. Generally, this redundancy occurs because a harmonic structure of an audio wave form does not fluctuate much (i.e., does not vary greatly in frequency) over a short period of time.

Thus, in alternative embodiments, the two dimensional array created by Huffman coding creates four values per coding interval; two values in time and two values in frequency. In certain embodiments, the array may comprise as many dimensions as necessary, without departing from the scope and essential features of embodiments of the present invention.

As designed, the Huffman coding will likely capture additional redundancy, and thus it is often desirable to transmit the Huffman values. In one embodiment, the Huffman coded scale factors are transmitted as a Huffman code word. In many embodiments, other parameters may optionally be transferred through the Huffman code words. For example, such parameters may include control of the user interface, the level of an output signal, or other suitable parameters of the real-time methods and apparatus.

Once the Huffman code word is transmitted to the server, the inverse of the above steps occurs. However, the server will only perform such inverse to the extent necessary to recover the time frequency coefficients. This generally does not include performing an inverse transform on the transmitted, encoded signal. Once the time frequency coefficients for each client signal are obtained, the appropriate gain and panning are applied, if desired, in order to construct channels of output signals.

A time frequency coefficient is then set, representing a mixed signal for one or perhaps more than one client. The new set of time frequency coefficients are then encoded and transmitted to the client. The client must perform a full decode to recover the wave form which can then be heard through headphones or speakers.

### Additional Exemplary Embodiments

In yet another exemplary embodiment of the present invention, specific operations of the encoder and decoder may be described in detail. For purposes of this exemplary embodiment, a signal interval of length “B” samples is a “block.” Additionally, adjacent blocks in time are denoted via increasing numbers, i.e., block 1, block 2, etc., where increasing numbers indicate more recent samples.

Operation of Encoder

In one embodiment, the encoder uses a Modified Discrete Cosine Transform (MDCT) to encode data signals. An MDCT takes a signal interval of length 2B samples, i.e, 2 blocks, and transforms it into a set of B time frequency coefficients. The encoder processes a waveform by applying an MDCT repeatedly such that application n of the MDCT processes blocks n−1 and n of time samples and produces block n time frequency coefficients, application n+1 of the MDCT processes blocks n1 and n+1 of time samples, and so forth. In this respect, each set of time samples processed by the MDCT overlaps 50% with the previously processed set of time samples.

Typically, the time frequency coefficients are scaled using scale factors and quantized to integer values. The scaling may reflect the application of a psycho-acoustic model as part of the quantization process. Single or multiple integer values of both the scale factors and the quantized to integer values may be further compressed using Huffman coding. This coded representation of a block of samples may comprise the payload of a data packet for transmission over a channel such as an IP network.

In certain instances it may be advantageous to carry more than one set of quantized time frequency coefficients in a data packet. For example, the coded representation of two sets of quantized time frequency coefficients representing two adjacent blocks of time signals, e.g. block n and block n+1, may be carried in a single data packet. It may be advantageous for a single Huffman codeword to represent a set of time frequency coefficients drawn from both block n and block n+1. For example, a Huffman codeword might represent two time frequency coefficients from block n that are adjacent in frequency, e.g. f and f+1 and two time frequency coefficients from block n+1 that have the same frequency values f and f+1. In this way, redundancies in both time and frequency can be exploited to achieve greater compression.

Operation of Decoder

In one embodiment, the decoder receives a data packet from the transmission channel. If the data packet contains the coded representation of a single block of signal, then the decoder performs the inverse Huffman coding of the scale factors and the inverse Huffman coding and inverse quantization of the time frequency coefficients to obtain B coefficients. It then transforms the B coefficients into 2B time samples. As a final step, the older B samples are overlapped with the newer B samples from the prior application of an Inverse Modified Discrete Cosine Transform (IMDCT), added together and output as the next B samples from the decoder. The newer B samples are saved for the next IMDCT operation.

Encoder-Decoder Delay

In one embodiment, by neglecting any delays due to transmission or computation, the decoder produces an output waveform that is a quantized and delayed version of the input, where the delay is equal to approximately 2B samples (actually 2B-1 samples). The following steps illustrate the arrival at such delay.

(1) Shift values in input signal buffer by B, i.e. B samples in second half of buffer are shifted into positions of B samples in first half; (2) Gather B new time samples into second half of input signal buffer. Buffer now contains 2B time samples; (3) Transform buffer of 2B times samples into B time frequency coefficients; (4) Quantize, Huffman code, format into data packet and transmit; (5) Receive data packet, Huffman decode and inverse quantize to get B time frequency coefficients; (6) Inverse Transform B time frequency coefficients into 2B times samples; (7) Overlap and add older B time samples from this transform with newer B time samples from the previous transform and output as B time samples; and (8) Repeat.

Operation of Mixer

In one embodiment, the mixer generally receives a data packet from the client. The mixer performs a Huffman decode and inverse quantization to get B time frequency coefficients. This process is repeated for each client.

For each client, the mixer mixes time frequency coefficients from the channels of all clients to form unique mix signals for each client. The unique mix signals are then ready for transmission to the respective clients.

Benefits of Frequency Domain v. Time Domain

Using the exemplary embodiments described above, if mixing was done in the time domain, the following additional steps would have to be completed in order to mix “time frequency coefficients from the channels of all clients to form unique mix signals for each client.”

First, the mixer would perform an inverse transform B time frequency coefficients into 2B times samples. Then, the mixer would overlap and add older B time samples from this transform with newer B time samples from the previous transform and output as B time samples. At that time, the time samples could be mixed from the channels of all clients to form unique mix signals for each respective client.

Next, the mixer would shift values in input signal buffer by B, i.e. B samples in second half of buffer would be shifted into positions of B samples in first half. Then, the mixer would load B new time samples from mix into second half of input signal buffer, whereby the buffer would then contains 2B time samples. From there, the mixer would transform buffer of 2B times samples into B time frequency coefficients, quantize the data, Huffman code the data, format into properly sized data packets and transmit back to the clients.

Thus, the decoder of the time-domain mix requires an additional delay relative to the frequency domain mix of approximately 2B samples.

While the foregoing is directed to embodiments of the present invention, other and further embodiments of the invention may be devised without departing from the basic scope thereof, and the scope thereof is determined by the claims that follow. It is understood that various embodiments described herein may be utilized in combination with any other embodiment described, without departing from the scope contained herein.

What is claimed is:

1. A method of processing data comprising:
generating a data signal at a client;
encoding the data signal at the client using a linear transform to generate a time frequency coefficients;
transmitting the time frequency coefficients to a server;
modifying the time frequency coefficients in accordance with instructions to create modified time frequency coefficients;
transmitting the modified time frequency coefficients to the client; and
decoding the modified time frequency coefficients using an inverse linear transform.

2. The method of claim 1, further comprising:
scaling and quantizing the time frequency coefficients at the client prior to transmitting the time frequency coefficients to the server.

3. The method of claim 1, further comprising:
compressing the time frequency coefficients using Huffman coding.

4. The method of claim 3, further comprising:
decompressing the Huffman coded time frequency coefficients using an inverse Huffman coding.

5. The method of claim 3, whereby a two dimensional array is created using Huffman coding.

6. The method of claim 3, further comprising:
generating a Huffman code word representing the time frequency coefficients.

7. The method of claim 6, wherein the Huffman code word further represents the instructions to create modified time frequency coefficients.

8. The method of claim 1, wherein the data signal comprises a multimedia data signal.

9. The method of claim 8, wherein the data signal comprises at least one of an audio or video data signal.

10. A method of mixing data signals comprising:
generating a first data signal at a first client and a second data signal at a second client;
encoding the first data signal at the first client using a linear transform to generate first time frequency coefficients;
encoding the second data signal at the second client using a linear transform to generate second time frequency coefficients;
transmitting the first and second time frequency coefficients to a server;
creating a first mix by combining the first and second time frequency coefficients in accordance with instructions from the first client;
creating a second mix by combining the first and second time frequency coefficients in accordance with instructions from the second client;
transmitting the first mix to the first client, and the second mix to the second client; and
decoding the first mix at the first client and the second mix at the second client, using an inverse linear transform.

11. The method of claim 10, wherein the first data signal and second data signal are each encoded using a modified discrete cosine transform.

12. The method of claim 11, wherein the first data signal and second data signal are each encoded by a process comprising:
taking a data signal interval having a length of two samples; and
transforming the data signal interval into a set of one sample of time frequency coefficients.

13. The method of claim 10, further comprising:
scaling and quantizing each of the first and second time frequency coefficients at the respective client prior to transmitting the time frequency coefficients to the server.

14. The method of claim 13, further comprising:
compressing the first and second time frequency coefficients using Huffman coding.

15. The method of claim 14, further comprising:
decompressing the Huffman coded first and second time frequency coefficients using an inverse Huffman coding prior to creating the first and second mix.

16. The method of claim 15, whereby a two dimensional array is created using Huffman coding.

17. The method of claim 10, wherein the data signal comprises a multimedia data signal.

18. The method of claim 17, wherein the data signal comprises at least one of an audio or video data signal.

19. A system comprising:
a first set of Huffman coded time frequency coefficients from a first client;
a second set of Huffman coded time frequency coefficients from a second client;
a mixer having a decoder, for mixing the first and second sets of Huffman coded time frequency coefficients;
a first unique mix, for the first client, generated by the mixer; and
a second unique mix, for the second client, generated by the mixer.

20. The system of claim 19, wherein the first and second set of Huffman coded time frequency coefficients each comprise a Huffman code word.
